(19) United States
(12) Patent Application Publication
(10) Pub. No.: US 2026/0348728 A1
(43) Pub. Date: Nov. 5, 2026

(54) METHOD FOR ESTIMATING THE AZIMUTH OF A MOTION SIMULATOR COMPRISING AT LEAST TWO AXES, IN ORDER TO SET IT TO NORTH

(71) Applicant: EXAIL, SAINT-GERMAIN-EN-LAYE (FR)

(72) Inventors: Mehdi BUSSUTIL, SAINT-GERMAIN-EN-LAYE (FR); Bernard VAU, SAINT-GERMAIN-EN-LAYE (FR)

(21) Appl. No.: 19/100,190

(22) PCT Filed: Aug. 3, 2023
(86) PCT No.: PCT/EP2023/071545

§ 371 Date: Jan. 31, 2025

(30) Foreign Application Priority Data
Aug. 4, 2022 (FR) FR2208105

(51) Int. Cl. G01C 19/38; G01C 25/00

(52) U.S. Cl. CPC G01C 19/38; G01C 25/005

(57) ABSTRACT

The invention relates to a method for estimating the azimuth, \hat{ψ}, of a base of a motion simulator by implementing a gyrometric system comprising at least one gyrometer attached to the plate of the motion simulator and applying a “maytagging” method in four positions in a first main sequence and in a second main sequence, corresponding to two opposite orientations of the plate, and wherein the positioning time of the plate for the measurements of the gyrometer or gyrometers in each of the four positions is less than or equal to half the correlation time of the Allan curve and wherein each of the first and second main sequences is repeated a predetermined number of times, N N>1, and general averages of differentials of the averages of the measurement obtained during the repetition of the first and second main sequences are calculated, the azimuth finally being estimated by solving a linear system comprising the general averages of the differentials.

### TECHNICAL FIELD

The present invention generally relates to the field of metrology devices and more particularly to the field of means for accurately determining the azimuth of a motion simulator in order, in particular, to orient it accurately. More specifically, it relates to a method for estimating the azimuth making it possible in particular to set to north a motion simulator comprising at least two axes.

### TECHNOLOGICAL BACKGROUND

The present invention thus relates to the field of motion simulators used for testing and calibrating inertial units, navigation units or, more generally, inertial components or systems. These motion simulators are electromechanical systems comprising one or more generally rotating axes nested within one another in a universal joint-type structure and enabling a plate to be set in motion. The tests and calibrations of the inertial units and the navigation units require the use of a motion simulator comprising at least two axes, the tested unit being attached to the plate.

For calibrating inertial components and systems, it is of the utmost importance that the azimuth of the reference frame associated with the base of the motion simulator is known with a high degree of accuracy (a few arc seconds). The reference used to determine the azimuth angle is typically the north and, the azimuth being known, the motion simulator can be directly “set to north”.

Also, generally, when a motion simulator is installed on site, one of the axes of its base is accurately oriented most often to the north, or to the east in other cases. This “setting to north” of the simulator is often performed by a service provider independent of the motion simulator manufacturer, because it requires the use of an approved, high-precision gyro-theodolite. This operation is expensive for the motion simulator manufacturer, and makes it dependent on an external organization.

In order to remedy these difficulties, it is proposed here a method for estimating the azimuth of the motion simulator base using only an inertial or navigation unit temporarily placed and attached on the plate of the motion simulator, and thus without the need to use the gyro-theodolite required in the conventional procedures of “setting to the north”.

It is reminded that the gyrometers, in particular those with an inertial or navigation unit, measure a speed of rotation in a Galilean reference frame and are that way sensitive to the effect of Earth's rotation. Compared to inertial units that include only gyrometers, navigation units include a GNSS receiver in addition to gyrometers. It is known that good gyrometers of current navigation units have a relatively low bias whose value is at most of a few hundreds, or even a few thousandths of a degree per hour (°/h). Thus, by means of a trihedron of gyrometers of an inertial or navigation unit, it is possible to relatively accurately estimate the direction of the Earth's rotation axis relative to the axes of said trihedron, and this property is exploited by north finders. On this subject, reference can be made for example to “Strapdown inertial navigation technology” by D. H. Titterton and J. L. Watson (Peter Peregrinus, 1997, chap. 9). Reference can also be made for example to “The usage of Gyros in north finding systems” by Q. Le Gall, rapport KTH, 2017 (http://www.diva-portal.se/smash/get/diva2:1110826/FULLTEXT01.pdf).

Also, as the angular positions of the motion simulator axes are known with a high accuracy (in the arc-second range), it is conceivable that it might be possible to use a navigation unit mounted on its plate in order to search for north, and to determine that way the azimuth of the motion simulator base.

The two most widespread techniques for finding north using gyrometers are “Carouseling” and “Maytagging”, and refer is made on this subject to the article “What is Mems gyrocompassing? Comparative analysis of Maytagging and Carouseling”, by I. P. Prikhodko, S. A. Zotov, A. Trusov, A. M. Shkel in Journal of Mircoelectromechanical systems, vol. 12, n°6, 2013.

The “maytagging” procedure (sometimes also called “Lasy Suzan”) is an azimuth detection method that consists in performing measurement acquisition during successive poses of a gyrometer whose measurement axis, also known as the sensitive axis, is substantially horizontal, the direction of the gyrometer measurement axis being changed by 180° about a vertical axis between two poses, which makes it possible to cancel the effect of the gyrometer bias on the azimuth estimation, by measurement differentiation. During the poses, the plate is static, the gyrometer sensitive axis is horizontal and the measurements are performed by the gyrometer. This known method makes it possible, most of time, to obtain azimuth estimation with an accuracy of the order of a few arc minutes. However, this accuracy is not sufficient within the framework of setting movement simulators to north, where an azimuth accuracy of the order of 10 to 15 arc seconds is generally required.

In this field, the following documents: ZHANG YONGJIAN ET AL: “Detection methods of Earth's rotation rate with a MEMS gyroscope”, 2015 12TH IEEE INTERNATIONAL CONFERENCE ON ELECTRONIC MEASUREMENT & INSTRUMENTS (ICEMI), IEEE, vol. 3, 16 Jul. 2015, pages 1552-1557, XP032913378; CN 110 501 028 A and EP 2 410 293 A1, are also known.

### DISCLOSURE OF THE INVENTION

The object of the present invention is to propose an improved procedure for estimating the base azimuth of a motion simulator having at least two axes, using measurements from a trihedron of gyrometers of an inertial or navigation unit temporarily placed and attached on the motion simulator plate, and which is an improvement of the “maytagging” method. It will be seen that, in alternative embodiments, only one gyrometer or two gyrometers can be used.

This improved procedure takes advantage, in an optimized way, of two advantages that significantly increase the azimuth estimation accuracy:
1) Being able to orient the gyrometers in two rotational degrees of freedom makes it possible to diversify the poses compared to the conventional “maytagging” procedure,
2) Using several gyrometers also makes it possible to improve the accuracy of estimation of the motion simulator azimuth.

The invention thus relates to a method for estimating the azimuth, \hat{ψ}, of a motion simulator base including a plate mounted on the base to rotate about at least two mutually perpendicular axes, the plate having a flat reference face defining a plate plane, in which
a gyrometric system including at least one gyrometer adapted to measure an angular speed of rotation of the plate about its measurement axis in an inertial reference frame is attached to the reference face of the plate,
at least four sessions of measurement of the angular speed of rotation of the plate are performed during at least four poses of the plate in four different positions of the plate during a first main sequence and in four positions of the plate during a second main sequence, the plate being static during its poses and the measurement axis of the gyrometer being horizontal during the plate poses,
in the first main sequence, the plate is positioned so that, during the plate poses, the reference face is oriented according to a first normal vector and the measurements are performed successively in the four successive plate pose positions,
in the second main sequence, the plate is positioned so that, during the plate poses, the reference face is oriented according to a second normal vector, opposite to the first normal vector, and the measurement sessions are performed successively in the four successive plate pose positions,
the four plate positions of each of the first and second main sequences being such that the horizontal measurement axis of the gyrometer is turned by an angle of 180° in absolute value between a first position and a second position, is turned by an angle of 90° in absolute value between the second position and a third position, is turned by an angle of 180° in absolute value between the third position and a fourth position,
the measurement sessions between each of the plate poses at each of the four plate positions being performed during substantially a same determined pose time t less than or equal to half the gyrometer's Allan curve correlation time, and the obtained measurements are averaged over this pose time to obtain an averaged session measurement,
in each of the first and second main sequences, two differentials of the averaged session measurements are calculated, including a first differential between the session measurement averaged at the first position and the session measurement averaged at the second position and a second differential between the session measurement averaged at the third position and the session measurement averaged at the fourth position,
each of the first and second main sequences is repeated a determined number of times N, N>1, and general averages of the differentials obtained by the repetition of the first and second main sequences are calculated, the azimuth being finally estimated by solving a linear system including the general averages of the differentials.

More generally and as an alternative, the invention can be implemented in such a way that the measurement sessions during each of the plate poses at each of the four plate positions are performed during a same determined pose time t less than the gyrometer's Allan curve correlation time, and the measurements obtained during this pose time is averaged to obtain an averaged session measurement.

Other non-limiting and advantageous features of the method according to the invention, taken individually or according to all the technically possible combinations, are the following:
the gyrometric system is an inertial unit or navigation unit or one or several independent gyrometers,
a gyrometer is specified by the standard deviation of measurements as a function of measurement time, the evolution of this standard deviation (corresponding to the “bias instability” of the gyrometer) having a minimum for a measurement duration called the “Allan curve correlation time”,
within the framework of the invention, a procedure derived from four-position “maytagging” is implemented twice for two opposite orientations of the plate, i.e. in the first main sequence, the reference face is oriented according to a first normal vector and, in the second main sequence, the reference face is oriented according to a second normal vector opposite to the first normal vector,
the gyrometric system includes a maximum of three gyrometers with mutually perpendicular measurement axes,
the gyrometric system includes a single gyrometer, the single gyrometer being attached to the reference face of the plate so that its measurement axis is parallel to the plate plane, the plate being horizontal and static during the poses of the plate in the four plate positions of the first main sequence and in the four plate positions of the second main sequence, the first and second orientation directions of the reference face of the plate being then along a vertical (i.e. the reference face has a vertical normal vector but the normal vectors are opposite between the two main sequences),
the gyrometric system includes several gyrometers with mutually perpendicular measurement axes, at least one gyrometer of which being attached to the plate in such a way that its measurement axis is parallel to the plate plane, during the plate poses in the four plate positions of the first main sequence and in the four plate positions of the second main sequence, the plate being horizontal, the first and second orientation directions of the reference face being then along a vertical (i.e. the reference face has a vertical normal vector but the normal vectors are opposite between the two main sequences),
the gyrometric system includes several gyrometers with mutually perpendicular measurement axes, at least two gyrometers of which being attached to the plate in such a way that their measurement axes are parallel to the plate plane, during the plate poses in the four plate positions of the first main sequence and in the four plate positions of the second main sequence, the plate being horizontal, the first and second orientation directions of the reference face being then along a vertical (i.e. the reference face has a vertical normal vector but the normal vectors are opposite between the two main sequences),
the plate of the motion simulator is moveable about at least two mutually perpendicular rotating axes,
the gyrometric system is attached to the plate reference face,
the gyrometric system is attached to the rotation centre of the plate reference face, said rotation centre corresponding to the crossing of an internal axis of the motion simulator with the plate plane,
the gyrometric system is attached to the rotation centre of the plate reference face, said rotation centre corresponding to the crossing of said at least two mutually perpendicular rotating axes of the motion simulator, including an internal axis and an external axis, about which the plate rotates,
the motion simulator plate is moveable about at least two mutually perpendicular rotating axes, an internal axis and an external axis,
the motion simulator plate is moveable about at least three mutually perpendicular rotating axes, including an internal axis and an external axis,
for the whole duration T of the measurements, the gyrometric system remains attached to the plate,
after azimuth estimation, the gyrometric system is removed from the plate,
a single gyrometer or several gyrometers including a set of gyrometers are implemented, the gyrometers having their measurement axes mutually perpendicular,
a maximum whole duration Tmax of the measurements is previously defined equal to a whole duration of the measurements with implementation of the invention but without iteration, N=1, and with a pose time τ equal to the Allan curve correlation time and at least one solution of a couple pose time τ and iteration number N is determined such that the pose time τ is less than or equal to half the Allan curve correlation time, and such that N>1 and such that it enables a whole measurement duration T less than the maximum whole duration Tmax,
a maximum whole duration Tmax of the measurements is previously defined equal to a whole duration of the measurements with implementation of the invention by without iteration, N=1, and with a pose time τ equal to the Allan curve correlation time and at least one solution of a couple pose time τ and iteration number N is determined such that the pose time τ is advantageously less than or equal to one-tenth of the Allan curve correlation time, and such that N>1 and such that is allows a whole duration of the measurements T less than the maximum whole duration Tmax,
several couples pose time τ and iteration number N are determined and that whose pose time τ is the shortest is implemented,
several couples pose time τ and iteration number N are determined and that whose iteration number N>1 is the highest is implemented,
several couples pose time τ and iteration number N are determined and that whose pose time τ is the longest and less than or equal to half the Allan curve correlation time is implemented,
several couples pose time τ and iteration number N are determined and that whose pose time τ is the longest and less than or equal to one-tenth of the Allan curve correlation time is implemented,
several couples pose time τ and iteration number N are determined and that whose iteration number N>1 is the smallest is implemented,
several couples pose time τ and iteration number N are determined and that which allows having the shortest whole measurement duration T is implemented, the whole measurement duration T being calculated by the product of τ by N, the time for positioning and orienting the plate being neglected with the respect to the pose time τ used, which is less than or equal to half the Allan curve correlation time,
several couples pose time τ and iteration number N are determined and that which allows having the shortest whole duration of measurements T is implemented, the whole measurement duration T being calculated by the product of τ by N and taking into account the time for positioning and orienting the plate,
the pose time τ is higher than the passage time between two successive positions rotated by an angle of 180° in a four-position main sequence,
the pose time is higher than the passage time between two successive positions rotated by an angle of 90° in a four-position main sequence,
the pose time is less than or equal to one-tenth of the Allan curve correlation time,
the pose time is less than or equal to one-twentieth of the Allan curve correlation time,
a single gyrometer is implemented,
a set of three gyrometers having their measurement axes mutually perpendicular is implemented, the set of three gyrometers being an inertial or navigation unit and the three gyrometers having substantially identical Allan curve correlation times, the measurement sessions being performed during the plate poses by two same gyrometers that have their two measurement axes horizontal during all the plate poses,
the inertial or navigation unit is arranged on the plate in such a way that its three gyrometers haver their measurement axes parallel to the plate plane,
in the case where an inertial or navigation unit is implemented, in the first main sequence, the plate is positioned in such a way that the measurement axis non parallel to the plate plane is directed upwards (i.e. the reference face has a vertical normal vector pointing upwards), and downwards in the second main sequence,
in the case where an inertial or navigation unit is implemented, in the first main sequence, the plate is positioned in such a way that the measurement axis non parallel to the plate plane is directed downwards (i.e. the reference face has a vertical normal vector pointing downwards), and upwards in the second main sequence,
two gyrometers having their measurement axes mutually perpendicular are implemented, the two gyrometers being attached to the plate in such a way that their measurement axes are horizontal during the plate poses and the two gyrometers have substantially identical Allan curve correlation times,
two gyrometers having their measurement axes parallel to the plate plane are implemented,
at least two gyrometers are implemented, and the gyrometers used for the measurement sessions during the poses have Allan curve correlation times that are significantly different from each other, and a pose time τ is implemented, which is less than or equal to half: average of the Allan curve correlation times of the gyrometers used, or the minimum value of the Allan curve correlation times of the gyrometers used, or the maximum value of the Allan curve correlation times of the gyrometers used,
at least two gyrometers are implemented, and the gyrometers used for the measurement sessions during the poses have Allan curve correlation times that are significantly different from each other, and a pose time τ is implemented, which is less than or equal to half the minimum value of the Allan curve correlation times of the gyrometers used,
the first and second main sequences are repeated N times sequentially, the first main sequence being repeated N times, then the second sequence repeated N times,
the first and second main sequences are repeated N times alternately, by N repetitions of a first main sequence executed once, followed by a second sequence executed once,
the first and second main sequences are repeated N times alternately and sequentially by repeating l times a first main sequence executed m times, followed by a second sequence executed m times, with m<N,l>1 and with the product of l by m equal to N,
once the azimuth of the table base, \hat{ψ}, has been determined and for a setting of the base to north, at least one mirror is placed on the base of the motion simulator and the base of said simulator is caused to perform mechanical rotations in order to compensate for the angle, said mechanical rotations being controlled by means of an auto-collimator targeting the above-mentioned mirrors.

### BRIEF DESCRIPTION OF THE DRAWINGS

FIG. 1 shows a simulated Allan curve of a gyrometer,

FIG. 2 schematically shows orientations of the measurement axis of a gyrometer in the four plate positions during a “maytagging”,

FIG. 3 shows a motion simulator with a gyrometric system attached to its plate.

### DETAILED DESCRIPTION OF AN EXEMPLARY EMBODIMENT

The following description in relation with the appended drawings, given by way of non-limiting examples, will allow a good understanding of what the invention consists of and of how it can be implemented.

In the present description, a motion simulator having two motorized rotating axes is considered, but the method of the invention can be applied to simulators having more than two motorized rotating axes by generalisation of the described operations.

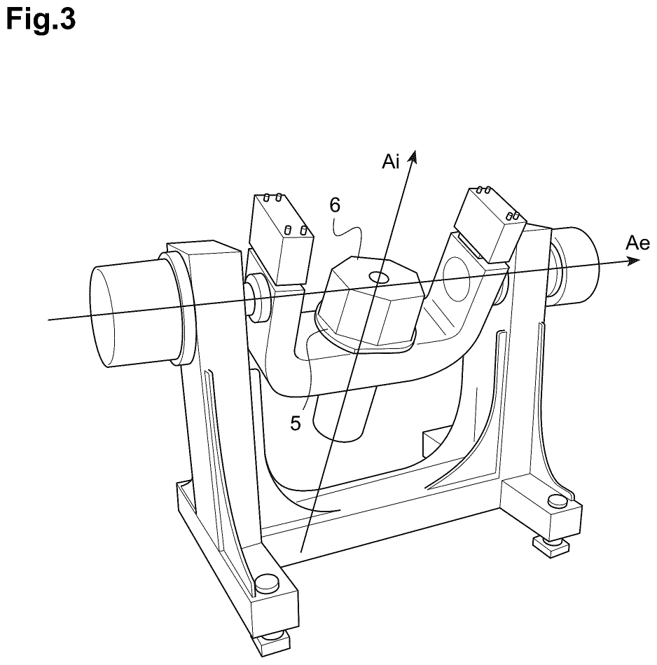

For the present description, certain assumptions are made and certain notations are used, which will now be presented in relation to FIG. 3 of an example of motion simulator:

The motion simulator includes a base that is fixed in a local geographic reference frame [symbol] _{L} and a plate 5 moveable about a motorized rotating axis called internal axis Ai, also called axis 1, zₛ, of the simulator. The plate 5 includes a flat reference face that defines a plate plane on which devices to be tested can be attached. The internal axis Ai of the simulator is orthogonal to the plate plane as can be seen in FIG. 3.

Typically, the motion simulator is placed on a fixed support relative to the ground. In the following, the words “plate” and “table”, which are considered as equivalent, will be used indifferently.

The local geographic reference frame [symbol] _{L} of axes (x, y, z) is such that axis x points to the north, axis z upwards, and axis y to west.

The reference frame attached to the motion simulator base [symbol] ₛ, of axes xₛ, yₛ, zₛ of which axis zₛ points upwards.

It is also assumed that the other motorized rotating axis, called external axis Ae, or also axis 2, of the simulator performs a rotation about axis xₛ (but it could also be axis yₛ). The reference frame associated with the external axis of the simulator, axis 2, is denoted [symbol] ₂ of axes (x₂, y₂, z₂). The angular position of this axis 2 is denoted θ₂ and when θ₂=0, x₂ is collinear with xₛ, y₂ is collinear with yₛ, z₂ is collinear with zₛ. The assumption is also made that the internal axis, axis 1, of the motion simulator is aligned along axis z₂. The reference frame associated with the internal axis, axis 1, is denoted [symbol] ₁ of axes (x₁, y₁, z₁). The angular position of this axis is denoted θ₁ and when θ₁=0, x₁ is collinear with x₂, y₁ is collinear with y₂, z₁ is collinear with z₂. A similar procedure could be contemplated in the case where the external axis would perform a rotation about axis zₛ and the internal axis would perform a rotation about axis x₂ or y₂: it would lead to different basic calculations than those described below, but the same result would be obtained.

The navigation unit used for the estimation and that is placed on the reference face of the motion simulator plate includes markers of the measurement axes x_{g}, y_{g} and z_{g} of its gyrometers. An inertial unit can be used instead of the navigation unit. The navigation unit is placed and attached to the motion simulator plate so that its measurement axis z_{g} is collinear with the internal axis Ai, axis 1, zₛ, of the simulator. Here again, this assumption is not restrictive.

In particular, if it is preferable that the indicated collinearity properties are respected, and thus also the centring of the gyrometer or the navigation unit on the plate, a potential misalignment with respect to horizontal of one or both of the measurement/sensitive axes only plays a second-order role in estimation errors. On the other hand, it is important that the measurement axis(es) of the gyrometer(s) used for the estimation measurements are in a horizontal plane during these measurements/poses.

Within the framework of the invention, it is possible to implement only one gyrometer or several gyrometers. For example, in FIG. 3, the element 6 attached to the plate is a navigation unit including three gyrometers and that is attached on the plate during the estimation. This unit is attached to the centre of rotation C of the plate 5 and with one of its measurement axes orthogonal to the internal axis Ai. As an alternative, it is possible to attach an inertial unit on the plate. In both cases, inertial unit or navigation unit, advantageously two measurement/sensitive axes are used for the estimation calculations as will be described hereinafter.

Indeed, the plate is substantially plane and defines a plate plane orthogonal to the internal axis, axis 1, zₛ, of the simulator (or even axis 1, zₛ, carries the plate plane) and on which plate is attached the navigation or inertial unit. That way, generally, the measurement axes x_{g}, y_{g} of the gyrometers of the navigation or inertial unit are in a plane parallel to the plate plane.

It will also be seen that, in the case where only one gyrometer is implemented in the so-called “degraded” mode described hereinafter, the measurement axis thereof is parallel to the plate plane.

It is to be noted that a plate is mentioned here to simplify explanations, but it can be any support set in motion in the motion simulator and serving to receive the equipment that will be tested in the latter.

The following notations are considered:
ψ: azimuth of the table: angle of axis xₛ of the reference frame of the table base with respect to axis x of the local geographical reference frame.
θ₁, θ₂: Angular position of axis 1 (internal axis) and 2 (external axis) of the table, axis 1 rotating about axis z₂, and axis 2 rotating about axis xₛ.
Δ: misalignment (i.e. rotation about axis z₁) of the gyrometer of measurement axis x_{g} with respect to vector x₁.
δ: orthogonality failure of the gyrometer of measurement axis y_{g} with respect to the gyrometer of measurement axis x_{g} according to axis z_{g} of the reference frame of the measurement axes associated with the gyrometer trihedron.
L: Latitude of the place of the motion simulator on Earth.
Ω: Earth's rotational velocity.
dₓ, d_{y}, d_{z}: disturbance terms on the measurements of the gyrometers of measurement axes x_{g}, y_{g}, and z_{g}, these disturbances including the bias, the bias variations and the noise.

$$( \begin{matrix}{ω}_{x} ( t ) \\ {ω}_{y} ( t ) \\ {ω}_{z} ( t )\end{matrix} ) :$$

measurement vector of the gyrometers of the navigation unit according to measurement axes x_{g}, y_{g}, z_{g}.

Errors due to scaling factor are neglected, as well as orthogonality failure of the gyros, except that of the gyrometer of measurement axis y with respect to that of axis x_{g} about axis z_{g}, denoted δ (cf. supra).

When the internal and external axes of the table are static, the measurements of the gyrometers of the navigation unit are given by the combination of the matrices of rotation of said axes and under the previous assumptions, the following is obtained:

$$( \begin{matrix}{ω}_{x} ( t ) \\ {ω}_{y} ( t ) \\ {ω}_{z} ( t )\end{matrix} ) = ( \begin{matrix}1 & 0 & 0 \\ - δ & 1 & 0 \\ 0 & 0 & 1\end{matrix} ) ( \begin{matrix}c ( {θ}_{1} + Δ ) & s ( {θ}_{1} + Δ ) & 0 \\ - s ( {θ}_{1} + Δ ) & c ( {θ}_{1} + Δ ) & 0 \\ 0 & 0 & 1\end{matrix} ) ( \begin{matrix}c {θ}_{2} & 0 & - s {θ}_{2} \\ 0 & 1 & 0 \\ s {θ}_{2} & 0 & c {θ}_{2}\end{matrix} ) ( \begin{matrix}c ψ & s ψ & 0 \\ - s ψ & c ψ & 0 \\ 0 & 0 & 1\end{matrix} ) ( \begin{matrix}Ω cL \\ 0 \\ Ω sL\end{matrix} ) + ( \begin{matrix}{d}_{x} ( t ) \\ {d}_{y} ( t ) \\ {d}_{z} ( t )\end{matrix} ) \qquad ( 1 )$$

The assumption is also made that the angular positions θ₁, θ₂ of the table are perfectly constant, all the disturbances being carried over the terms dₓ(t), d_{y}(t), d_{z}(t).

In the following is described a procedure for estimating the azimuth ψ by acquisition of measurements provided by the gyrometers of a navigation unit with the gyrometers of measurement axes x_{g} and y_{g}. These measurement axes x_{g} and y_{g} are in the plane or parallel to the plane defined by the plate or, when the plane is horizontal, the measurement axis z_{g} is vertical. The measurements along the measurement axis z_{g} are not useful in this example and the gyrometers of measurement axes x_{g} and y_{g} can be qualified as useful gyrometers and used gyrometers (for azimuth estimation). In practice, given that the measurement axes of the gyrometers are perpendicular to each other, and that the measurements have to be performed with the same gyrometer(s), each having horizontal measurement axes (thus in a plane), there can only be one or two useful/used gyrometers. These acquisitions are divided into two sub-procedures and in any case they are performed when the plate is horizontal. The motion simulator has thus to be positioned in such a way that the plate plane is horizontal (and hence the measurement axis(es) of the gyrometers are horizontal during the measurements/poses). For that purpose, a previous calibrations is made using levels.

The two sub-procedures (or main sequences) are:
1) First sub-procedure also called first main sequence: The navigation unit has its vertical axis z_{g} that points upwards, which corresponds to the position θ₂=0 of axis 2 of the table, which corresponds to a first horizontal orientation of the table. In this situation, the instantaneous speeds measured at instant t on the measurement axes x_{g} and y_{g} of the gyrometers are denoted ωₓ₀(t), ω_{y0}(t)
2) Second sub-procedure also called second main sequence: The navigation unit has its vertical axis z_{g} that points downwards, which also corresponds to the position θ₂=π of axis 2 of the table, which corresponds to a second horizontal orientation of the table, of opposite direction with respect to the first orientation of the table. In this situation, the instantaneous speeds at instant t on the measurement axes x_{g} and y_{g} of the gyrometers are denoted: ω_{xπ}(t), ω_{yπ}(t)

As regards the gyrometer of measurement axis x_{g} of the navigation unit, the instantaneous speeds can be expressed from the relation (1) as a function, in particular of θ₁:

$${ω}_{x 0} ( t , {θ}_{1} ) = cos ( {θ}_{1} + Δ + ψ ) Ω cos L + {d}_{x} ( t ) = ( cos {θ}_{1} cos ( Δ + ψ ) - sin {θ}_{1} sin ( Δ + ψ ) ) Ω cos L + {d}_{x} ( t ) \qquad ( 2 )$$

$${ω}_{x π} ( t , {θ}_{1} ) = - cos ( {θ}_{1} + Δ - ψ ) Ω cos L + {d}_{x} ( t ) = ( - cos {θ}_{1} cos ( Δ - ψ ) + sin {θ}_{1} sin ( Δ - ψ ) ) Ω cos L + {d}_{x} ( t ) \qquad ( 3 )$$

Likewise, for the measurements of the gyrometer of measurement axis y_{g} of the navigation unit:

$${ω}_{y 0} ( t , {θ}_{1} ) = - sin ( {θ}_{1} + Δ + ψ + δ ) Ω cos L + {d}_{y} ( t ) = ( - cos {θ}_{1} sin ( Δ + ψ + δ ) - sin {θ}_{1} cos ( Δ + ψ + δ ) ) Ω cos L + {d}_{y} ( t ) \qquad ( 4 )$$

$${ω}_{y π} ( t , {θ}_{1} ) = + sin ( {θ}_{1} + Δ - ψ + δ ) Ω cos L + {d}_{y} ( t ) = ( cos {θ}_{1} sin ( Δ - ψ + δ ) + s i n {θ}_{1} cos ( Δ - ψ + δ ) ) Ω cos L + {d}_{y} ( t ) \qquad ( 5 )$$

### 1) First Sub-Procedure: Series of Acquisitions for θ₂=0

The measurements with θ₂=0 makes it possible to have an estimate \hat{χ}ₓ₀=\hat{Δ}+\hat{ψ} with the gyrometer of measurement axis x_{g} of variance

$${σ}_{x 0}^{2}$$

and an estimate \hat{χ}_{y0}=\hat{Δ}+\hat{ψ}+\hat{δ} with the gyrometer of measurement axis y_{g}, of variance

$${σ}_{y 0}^{2} .$$

In this example, the orientation of the plate with θ₂=0 corresponds to a horizontal plate looking upwards (i.e. the reference face has a vertical normal vector pointing upwards, a normal vector being a vector perpendicular to a surface, herein the reference face) and then the orientation of the plate with θ₂=π (see hereinafter) corresponds to a horizontal plate locking downwards. In another example of implementation, the orientation of the plate with θ₂=0 corresponds to a horizontal plate looking downwards and then the orientation of the plate with θ₂=π corresponds to a horizontal plate looking upwards.

The parameters \hat{χ}ₓ₀, \hat{χ}_{y0} are estimated by a method derived from four-position “maytagging.

For that purpose, an initial position of axis 1 denoted θ₁₍₀₎, called the first measurement position is defined, and an acquisition is made, during a time τ corresponding to a pose, of measurements of the gyrometers of measurement axes x_{g} and y_{g} at this position and corresponding to a measurement session. The time τ can thus be qualified as pose time. The averages of the measurements during the pose time on these gyrometers of measurement axes x_{g} and y_{g} are calculated and denoted ω̅ₓ₀ (θ₁₍₀₎) ω̅_{y0}(θ₁₍₀₎). Therefore, during a pose corresponding to an acquisition, for each useful gyrometer, several measurements are performed and these measurements are averaged to obtain an average over a pose.

Thereafter, the axis 1 is subjected to a rotation of π radians to pass to a second measurement position, and an acquisition is made again during, preferably, the same pose time τ, which makes it possible to calculate and obtain the averages of a pose denoted ω̅ₓ₀(θ₁₍₀₎+π) and ω̅_{y0}(θ₁₍₀₎+π).

Then, for each measurement axis x_{g} and y_{g} a differential ω̅ₓ₀(θ₁₍₀₎) and ω̅_{y0}(θ₁₍₀₎) is computed such that

$${\overline{\overline{ω}}}_{x 0} ( {θ}_{1 ( 0 )} ) = \frac{1}{z} ( {\overline{ω}}_{x 0} ( {θ}_{1 ( 0 )} ) - {\overline{ω}}_{x 0} ( {θ}_{1 ( 0 )} + π ) ) \qquad ( 6 )$$

$$and$$

$${\overline{\overline{ω}}}_{y 0} ( {θ}_{1 ( 0 )} ) = \frac{1}{2} ( {\overline{ω}}_{y0} ( {θ}_{1 ( 0 )} ) - {\overline{ω}}_{y 0} ( {θ}_{1 ( 0 )} + π ) ) \qquad ( 7 )$$

This differentiation is “maytagging” itself.

Thereafter, axis 1 of the table is placed at position θ₁₍₀₎+φ, called the third measurement position, with preferably

$$φ = \frac{π}{2} or φ = - \frac{π}{2}$$

and an acquisition is made of the measurements of the gyrometers of measurement axes x_{g} and y_{g} preferably during the same pose time τ, and an average thereof is made in order to obtain the average values of a pose ω̅ₓ₀(θ₁₍₀₎+φ) and ω̅_{y0}(θ₁₍₀₎+φ).

It can be noted that these values

$$φ = \frac{π}{2} or φ = - \frac{π}{2}$$

are optimal with respect to other values.

Thereafter, axis 1 of the table will be moved to the position θ₁₍₀₎+φ+π at a fourth measurement position and an acquisition is made again of the measurements of the gyrometers of measurement axes x_{g} and y_{g} preferably during the same pose time τ, then these acquisitions are averaged in order to obtain the average values of a pose on the gyrometers x_{g} and y_{g} denoted ω̅ₓ₀(θ₁₍₀₎+φ+π) and ω̅_{y0}(θ₁₍₀₎+φ+π).

It is to be noted that the four positions of axis 1 define four positions of the table and also four positions of the measurement axes x_{g}, y_{g}, and z_{g}, due to the fact that the inertial unit is attached to the table.

The differentials

$${\overline{\overline{ω}}}_{x 0} ( {θ}_{1 ( 0 )} + φ ) and {\overline{\overline{ω}}}_{y 0} ( {θ}_{1 ( 0 )} + φ )$$

are then calculated, such that

$${\overline{\overline{ω}}}_{x 0} ( {θ}_{1 ( 0 )} + φ ) = \frac{1}{2} ( {\overline{ω}}_{x 0} ( {θ}_{1 ( 0 )} + φ ) - {\overline{ω}}_{x 0} ( {θ}_{1 ( 0 )} + π + φ ) ) \qquad ( 8 )$$

$$and$$

$${\overline{\overline{ω}}}_{y 0} ( {θ}_{1 ( 0 )} + φ ) = \frac{1}{2} ( {\overline{ω}}_{y 0} ( {θ}_{1 ( 0 )} + φ ) - {\overline{ω}}_{y 0} ( {θ}_{1 ( 0 )} + π + φ ) ) \qquad ( 9 )$$

Following a sequence of acquisitions at 4 positions, we thus have two differentials per measurement axis, which makes four differentials for the two measurement axes x_{g} and y_{g}.

In practice, this sequence of acquisitions at 4 positions (θ₁₍₀₎, θ₁₍₀₎+π, θ₁₍₀₎+φ, θ₁₍₀₎+φ+π) is iterated/renewed N times, enabling to determine at each iteration the differentials at each pose:

$${\overline{\overline{ω}}}_{x 0}^{( i )} ( {θ}_{1 ( 0 )} )$$

$${\overline{\overline{ω}}}_{x 0}^{( i )} = ( {θ}_{1 ( 0 )} + φ )$$

$${\overline{\overline{ω}}}_{y 0}^{( i )} = ( {θ}_{1 ( 0 )} )$$

$${\overline{\overline{ω}}}_{y 0}^{( i )} = ( {θ}_{1 ( 0 )} + φ )$$

The index (i) relating to the i-th iteration of the N iterations.

At the end of the N iterations (each iteration being consisted of 4 sequences de pose at the 4 positions (θ₁₍₀₎, θ₁₍₀₎+π, θ₁₍₀₎+π, θ₁₍₀₎+φ+π), general averages of the differentials are calculated:

$${\overline{\overline{\overline{ω}}}}_{x 0} = ( {θ}_{1 ( 0 )} ) = \frac{1}{N} {\sum }_{i = 1}^{N} {\overline{\overline{ω}}}_{x 0}^{( i )} ( {θ}_{1 ( 0 )} ) \qquad ( 10 )$$

$${\overline{\overline{\overline{ω}}}}_{x 0} = ( {θ}_{1 ( 0 )} + φ ) = \frac{1}{N} {\sum }_{i = 1}^{N} {\overline{\overline{ω}}}_{x 0}^{( i )} ( {θ}_{1 ( 0 )} + φ ) \qquad ( 11 )$$

$${\overline{\overline{\overline{ω}}}}_{y 0} = ( {θ}_{1 ( 0 )} ) = \frac{1}{N} {\sum }_{i = 1}^{N} {\overline{\overline{ω}}}_{y 0}^{( i )} ( {θ}_{1 ( 0 )} ) \qquad ( 12 )$$

$${\overline{\overline{\overline{ω}}}}_{y 0} = ( {θ}_{1 ( 0 )} + φ ) = \frac{1}{N} {\sum }_{i = 1}^{N} {\overline{\overline{ω}}}_{y 0}^{( i )} ( {θ}_{1 ( 0 )} + φ ) \qquad ( 13 )$$

Thereafter, taking into account the relation (2), it can be written:

$${\overline{\overline{\overline{ω}}}}_{x 0} ( {θ}_{1 ( 0 )} ) = [ cos ( {θ}_{1 ( 0 )} ) cos ( {\hat{χ}}_{x 0} ) - sin ( {θ}_{1 ( 0 )} ) sin ( {\hat{χ}}_{x 0} ) ] Ωcos L + {ϵ}_{x 0} \qquad ( 14 )$$

$${\overline{\overline{\overline{ω}}}}_{x 0} ( \text{} {θ}_{1 ( 0 )} + φ ) = [ \text{} cos ( {θ}_{1 ( 0 )} + φ ) cos ( {\hat{χ}}_{x 0} ) - sin ( {θ}_{1 ( 0 )} + φ ) sin ( {\hat{χ}}_{x 0} ) ] Ωcos L + {ϵ}_{x 0}^{′} \qquad ( 15 )$$

where ϵₓ and ϵ′ₓ are error terms.

In this document, symbol [symbol] indicates the estimate of the variable in brackets.

The relations (14) and (15) thus make it possible to determine the estimates sin (\hat{χ}ₓ₀), and cos (\hat{χ}ₓ₀) by solving the linear system:

$$[ \begin{matrix}cos ( {\hat{χ}}_{x 0} ) \\ sin ( {\hat{χ}}_{x 0} )\end{matrix} ] = {[ \begin{matrix}cos ( {θ}_{1 ( 0 )} ) & - sin ( {θ}_{1 ( 0 )} ) \\ cos ( {θ}_{1 ( 0 )} + φ ) & - sin ( {θ}_{1 ( 0 )} + φ )\end{matrix} ]}^{- 1} [ \begin{matrix}{\overline{\overline{\overline{ω}}}}_{x 0} ( {θ}_{1 ( 0 )} ) \\ {\overline{\overline{\overline{ω}}}}_{x 0} ( {θ}_{1 ( 0 )} + φ )\end{matrix} ] \qquad ( 16 )$$

And thus, the angle \hat{χ}ₓ₀=\hat{Δ}+\hat{ψ} can be determined from sin (\hat{χ}ₓ₀) and cos (\hat{χ}ₓ₀) using an arctangent function (or atan 2) because

$$tan {\hat{χ}}_{x 0} = \frac{sin ( {\hat{χ}}_{x 0} )}{cos ( {\hat{χ}}_{x 0} )} \qquad ( 17 )$$

Likewise, based on relation (4), it can be written

$${\overline{\overline{\overline{ω}}}}_{y 0} ( {θ}_{1 ( 0 )} ) = [ - cos ( {θ}_{1 ( 0 )} ) sin ( {\hat{χ}}_{y 0} ) - sin ( {θ}_{1 ( 0 )} ) cos ( {\hat{χ}}_{y 0} ) ] Ωcos L + {ϵ}_{y 0} \qquad ( 18 )$$

$${\overline{\overline{\overline{ω}}}}_{y 0} ( {θ}_{1 ( 0 )} + φ ) = [ \text{} - cos ( {θ}_{1 ( 0 )} + φ ) sin ( {\hat{χ}}_{y 0} ) - sin ( {θ}_{1 ( 0 )} + φ ) cos ( {\hat{χ}}_{y 0} ) ] Ωcos L + {ϵ}_{y 0}^{′} \qquad ( 19 )$$

And likewise

$$[ \begin{matrix}sin ( {\hat{χ}}_{y 0} ) \\ cos ( {\hat{χ}}_{y 0} )\end{matrix} ] = {\frac{- 1}{Ω cos L} [ \begin{matrix}cos ( {θ}_{1 ( 0 )} ) & sin ( {θ}_{1 ( 0 )} ) \\ cos ( {θ}_{1 ( 0 )} + φ ) & sin ( {θ}_{1 ( 0 )} + φ )\end{matrix} ]}^{- 1} [ \begin{matrix}{\overline{\overline{\overline{ω}}}}_{y 0} ( {θ}_{1 ( 0 )} ) \\ {\overline{\overline{\overline{ω}}}}_{y 0} ( {θ}_{1 ( 0 )} + φ )\end{matrix} ] \qquad ( 20 )$$

Which makes it possible to deduce \hat{χ}_{y0}=\hat{Δ}+\hat{ψ}+\hat{δ}.

Thus, at the end of the first sub-procedure in which axis z_{g} of the navigation unit is kept vertical, pointing upwards, \hat{χ}ₓ₀=\hat{Δ}+\hat{ψ} and \hat{χ}_{y0}=\hat{Δ}+\hat{ψ}+\hat{δ} have been estimated. The variances

$${σ}_{x 0}^{2} and {σ}_{y 0}^{2} ,$$

can also be estimated using the propagation properties of the uncertainties from the estimates of the variances of

$${\overline{\overline{\overline{ω}}}}_{x 0} ( {θ}_{1 ( 0 )} ) , {\overline{\overline{\overline{ω}}}}_{x 0} ( {θ}_{1 ( 0 )} + φ ) , {\overline{\overline{\overline{ω}}}}_{y 0} ( {θ}_{1 ( 0 )} ) , {\overline{\overline{\overline{ω}}}}_{y 0} ( {θ}_{1 ( 0 )} + φ )$$

that ensue from the expressions (10) to (13).

### 2) Second Sub-Procedure: Series of Acquisitions for θ₂=π

The measurements with θ₂=π makes it possible to have an estimate \hat{ω}_{xπ}=\hat{Δ}−\hat{ψ} with the gyrometer of measurement axis x_{g} of variance

$${σ}_{x π}^{2}$$

and makes it possible to have an estimate \hat{χ}_{yπ}=\hat{Δ}−ψ̅+δ with the gyrometer of measurement axis y_{g}, of variance

$${σ}_{y π}^{2} .$$

The parameters \hat{χ}_{xπ}, \hat{χ}_{yπ} are also estimated by a method derived from four-position” maytagging. This second four-position sub-procedure being similar to the first sub-procedure, it is not described again and detailed in this portion of the disclosure.

This second sub-procedure makes it possible to obtain the general averages of the differentials

$${\overline{\overline{\overline{ω}}}}_{x π} ( {θ}_{1 ( 0 )} ) , {\overline{\overline{\overline{ω}}}}_{x π} ( {θ}_{1 ( 0 )} + φ ) , {\overline{\overline{\overline{ω}}}}_{y π} ( {θ}_{1 ( 0 )} ) and {\overline{\overline{\overline{ω}}}}_{y π} ( {θ}_{1 ( 0 )} + φ ) ,$$

where the initial value θ₁₍₀₎ and the angle φ (preferably

$$- \frac{π}{2} or \frac{π}{2} )$$

are not necessarily the same as in the first sub-procedure.

In practice, the first position for the second sub-procedure (or second main sequence) can be any angular position with respect to the first position of the first sub-procedure (or first main sequence).

Moreover, the passage from a plate position to the following in each of the first and second sub-procedures (or main sequences) can be made in a direction of rotation of the plate or the other without affecting the estimation results, hence the indication in absolute value of the rotation angles of the plate.

Based on relation (3), it can then be written

$${\overline{\overline{\overline{ω}}}}_{x π} ( {θ}_{1 ( 0 )} ) = [ - cos ( {θ}_{1 ( 0 )} ) cos ( {\hat{χ}}_{x π} ) + sin ( {θ}_{1 ( 0 )} ) sin ( {\hat{χ}}_{x π} ) ] Ωcos L + {ϵ}_{x π} \qquad ( 21 )$$

$${\overline{\overline{\overline{ω}}}}_{x π} ( {θ}_{1 ( 0 )} + φ ) = [ \text{} - cos ( {θ}_{1 ( 0 )} + φ ) cos ( {\hat{χ}}_{x π} ) + sin ( {θ}_{1 ( 0 )} + φ ) sin ( {\hat{χ}}_{x π} ) ] Ωcos L + {ϵ}_{x π}^{′} \qquad ( 22 )$$

And the determination of \hat{χ}_{xπ} is made by solving the linear system

$$[ \begin{matrix}cos ( {\hat{χ}}_{x π} ) \\ sin ( {\hat{χ}}_{x π} )\end{matrix} ] = {[ \begin{matrix}- cos ( {θ}_{1 ( 0 )} ) & sin ( {θ}_{1 ( 0 )} ) \\ - cos ( {θ}_{1 ( 0 )} + φ ) & sin ( {θ}_{1 ( 0 )} + φ )\end{matrix} ]}^{- 1} [ \begin{matrix}{\overline{\overline{\overline{ω}}}}_{x π} ( {θ}_{1 ( 0 )} ) \\ {\overline{\overline{\overline{ω}}}}_{x π} ( {θ}_{1 ( 0 )} + φ )\end{matrix} ] \qquad ( 23 )$$

Likewise, based on relation (5), we have

$${\overline{\overline{\overline{ω}}}}_{y π} ( {θ}_{1 ( 0 )} ) = [ cos ( {θ}_{1 ( 0 )} ) sin ( {\hat{χ}}_{y π} ) + sin ( {θ}_{1 ( 0 )} ) cos ( {\hat{χ}}_{y π} ) ] Ωcos L + {ϵ}_{y π} \qquad ( 24 )$$

$$and$$

$${\overline{\overline{\overline{ω}}}}_{y π} = ( {θ}_{1 ( 0 )} + φ ) = [ \text{} cos ( {θ}_{1 ( 0 )} + ϕ ) sin ( {\hat{χ}}_{y π} ) + sin ( {θ}_{1 ( 0 )} + ϕ ) cos ( {\hat{χ}}_{y π} ) ] Ωcos L + {ϵ}_{y π}^{′} \qquad ( 25 )$$

Hence, the determination of \hat{χ}_{yπ} by solving

$$[ \begin{matrix}sin ( {\hat{χ}}_{y π} ) \\ cos ( {\hat{χ}}_{y π} )\end{matrix} ] = {[ \begin{matrix}cos ( {θ}_{1 ( 0 )} ) & sin ( {θ}_{1 ( 0 )} ) \\ cos ( {θ}_{1 ( 0 )} + φ ) & sin ( {θ}_{1 ( 0 )} + φ )\end{matrix} ]}^{- 1} [ \begin{matrix}{{ω}^{≡}}_{y π} ( {θ}_{1 ( 0 )} ) \\ {{ω}^{≡}}_{y π} ( {θ}_{1 ( 0 )} + φ )\end{matrix} ] \qquad ( 26 )$$

Therefore, at the end of the second sub-procedure \hat{χ}_{xπ}=\hat{Δ}−\hat{ψ} and \hat{χ}_{yπ}=\hat{Δ}−\hat{ψ}+δ, have been estimated, with their respective variances

$${σ}_{x π}^{2} , {σ}_{y π}^{2} .$$

### 3) Final Estimation of the Angles ψ, Δ, δ

Following the first and second sub-procedures, the following system of equations is deduced:

$$( \begin{matrix}+ 1 & 1 & 0 \\ - 1 & 1 & 0 \\ + 1 & 1 & 1 \\ - 1 & 1 & 1\end{matrix} ) ( \begin{matrix}\hat{ψ} \\ \hat{Δ} \\ δ\end{matrix} ) = ( \begin{matrix}{\hat{χ}}_{x 0} \\ {\hat{χ}}_{x π} \\ {\hat{χ}}_{y 0} \\ {\hat{χ}}_{y π}\end{matrix} ) \qquad ( 27 )$$

$$Assuming M = ( \begin{matrix}+ 1 & 1 & 0 \\ - 1 & 1 & 0 \\ + 1 & 1 & 1 \\ - 1 & 1 & 1\end{matrix} )$$

And thus the estimates \hat{ψ}, \hat{Δ}, \hat{δ} are determined using the pseudo-inverse of M

$$( \begin{matrix}\hat{ψ} \\ \hat{Δ} \\ δ\end{matrix} ) = {( {M}^{T} M )}^{- 1} {M}^{T} ( \begin{matrix}{\hat{χ}}_{x 0} \\ {\hat{χ}}_{x π} \\ {\hat{χ}}_{y 0} \\ {\hat{χ}}_{y π}\end{matrix} ) \qquad ( 28 )$$

The uncertainties are deduced from the uncertainty propagation properties. It is shown in particular that:

$$var ( \hat{ψ} ) = {M}^{+} ( 1 , : ) ( \begin{matrix}{σ}_{x 0}^{2} & 0 & 0 & 0 \\ 0 & {σ}_{x π}^{2} & 0 & 0 \\ 0 & 0 & {σ}_{y 0}^{2} & 0 \\ 0 & 0 & 0 & {σ}_{y π}^{2}\end{matrix} ) {( {M}^{+} ( 1 , : ) )}^{T} \qquad ( 29 )$$

where var(\hat{ψ}) is the variance of the estimate of the table azimuth.

The whole azimuth estimation process can therefore be summed up in two methods derived from “maytagging” (one for orienting the plate at θ₂=0, the other for orienting it at θ₂=π), each being based on four positions (θ₁₍₀₎, θ₁₍₀₎+π, θ₁₍₀₎+φ, θ₁₍₀₎+φ+π) of the plate and thus of the gyrometers' measurement axes. At each position, a pose is made, during which measurement acquisitions are performed by the gyrometers and are averaged. Once the averaged measurements obtained at the four positions, differentials of the averages for each measurement axis are calculated, one differential per axis. This is made for the two orientations of the plate. These measurement acquisitions at the four positions for the two orientations of the plate and calculations of averages over the pose time and of differentials are renewed N times and general averages of the differentials are finally calculated. The azimuth being then estimated by solving a linear system including the general averages of the differentials.

The two sub-procedures can be performed sequentially, i.e. one after the other, the N times of the first sub-procedure followed by N times the second sub-procedure, or on the contrary, as an alternative, by performing once the measurements at the four positions at (θ₁₍₀₎, θ₁₍₀₎+π, θ₁₍₀₎+φ, θ₁₍₀₎+φ+π) for θ₂=0, then once for the measurements at the four positions at (θ₁₍₀₎, θ₁₍₀₎+π, θ₁₍₀₎+φ, θ₁₍₀₎+φ+π) for θ₂=π then returning to θ₂=0 and doing again the sequence N times. Combinations are possible between the sequential and the alternately.

In fact, the single constraint, linked to the “maytagging”, is that a pose enabling to determine ω̅ₓ₀(θ₁₍₀₎) ω̅_{y0}(θ₁₍₀₎) (respectively ω̅_{xπ}(θ₁₍₀₎) ω_{yπ}(θ₁₍₀₎)) is followed by a pose enabling to determine ω̅ₓ₀(θ₁₍₀₎+π) ω̅_{y0}(θ₁₍₀₎+π) (respectively ω_{xπ}(θ₁₍₀₎+π) ω̅_{yπ}(θ₁₍₀₎+π)).

FIG. 2 schematically shows the measurement axes of a gyrometer used in the four pose positions of the motion simulator plate with numbering 1, 2, 3, 4 corresponding to the successive positions of the plate, these measurement axes being in a horizontal plane. In first position 1, an angular offset from the reference frame is indicated.

The procedure described so far delivers quality results for azimuth estimation. It is however possible to implement a somewhat “degraded” azimuth estimation procedure using acquisitions/measurements with only one gyrometer, for example a gyrometer of axis x_{g}. In this latter case, the above-mentioned sub-procedures will enable to obtain the estimates \hat{χ}ₓ₀ and χ_{xπ}, which enable to deduce \hat{ψ} and \hat{Δ} due to the fact that, in this case, the relation (27) is reduced to

$$( \begin{matrix}+ 1 & 1 \\ - 1 & 1\end{matrix} ) ( \begin{matrix}\hat{ψ} \\ \hat{Δ}\end{matrix} ) = ( \begin{matrix}{\hat{χ}}_{x 0} \\ {\hat{χ}}_{x π}\end{matrix} ) \qquad ( 30 )$$

Likewise, if the only gyrometer used for the estimation is the gyrometer of axis y_{g}, the relation (27) is reduced to

$$( \begin{matrix}+ 1 & 1 \\ - 1 & 1\end{matrix} ) ( \begin{matrix}\hat{ψ} \\ \hat{Δ} + \hat{δ}\end{matrix} ) = ( \begin{matrix}{\hat{χ}}_{y 0} \\ {\hat{χ}}_{y π}\end{matrix} ) \qquad ( 31 )$$

Using only one gyrometer is considered as a degraded mode because the variances on the estimates and in particular on w will be necessarily higher than if information coming from two gyrometers of measurement axes x_{g} and y_{g} are used (for an identical whole measurement duration). Nevertheless, this degraded mode may be useful if, instead of performing the present characterization with an inertial or navigation unit, it is desired to perform it with a single gyrometer.

In any case, the purpose is to obtain estimates \hat{ψ}, \hat{Δ}, \hat{δ} and \hat{χ}ₓ₀, \hat{χ}_{y0}, and/or \hat{χ}_{xπ}, \hat{χ}_{yπ} as accurate as possible, for a given whole measurement duration T and substantially corresponding to the sum of the pose times t, a measurement acquisition of the gyrometers taking a pose time τ to be performed. In practice, within the framework of the invention, the time for positioning, orienting and stabilizing the plate is negligible with respect to the pose time τ used and it can be considered that the whole measurement duration is substantially the product of N by τ.

This means that the variances

$${σ}_{x 0}^{2} , {σ}_{y 0}^{2} , {σ}_{x π}^{2} , {σ}_{y π}^{2}$$

must be as small as possible. These variances depend essentially on the noise that affects the measurements of the gyrometers and on the pose time of the various sequences.

In the following, the expression var(⋅) denotes the variance of the quantity in brackets.

The minimization of uncertainties on \hat{ψ}, \hat{Δ}, \hat{δ} amounts in fine in minimizing

$$var ( {\overline{\overline{\overline{ω}}}}_{x 0} ( {θ}_{1 ( 0 )} ) ) , var ( {\overline{\overline{\overline{ω}}}}_{x 0} ( {θ}_{1 ( 0 )} + φ ) ) ,$$

$$var ( {\overline{\overline{\overline{ω}}}}_{y 0} ( {θ}_{1 ( 0 )} ) ) , var ( {\overline{\overline{\overline{ω}}}}_{y 0} ( {θ}_{1 ( 0 )} + φ ) ) and$$

$$var ( {\overline{\overline{\overline{ω}}}}_{x π} ( {θ}_{1 ( 0 )} ) ) , var ( {\overline{\overline{\overline{ω}}}}_{x π} ( {θ}_{1 ( 0 )} + φ ) ) ,$$

$$var ( {\overline{\overline{\overline{ω}}}}_{y π} ( {θ}_{1 ( 0 )} ) ) , var ( {\overline{\overline{\overline{ω}}}}_{y π} ( {θ}_{1 ( 0 )} + φ ) ) .$$

But taking into account relations (10) to (13), (assuming that realisations

$${\overline{\overline{ω}}}_{x 0}^{( i )} = ( {θ}_{1 ( 0 )} )$$

are independent from each other), we have:

$$var ( {\overline{\overline{\overline{ω}}}}_{x 0} = ( {θ}_{1 ( 0 )} ) ) = \frac{1}{N} var ( {\overline{\overline{ω}}}_{x 0}^{( i )} ( {θ}_{1 ( 0 )} ) ) \qquad ( 32 )$$

But, due to relation (6) and assuming that var (ω̅ₓ₀(θ₁₍₀₎))=var (ω̅ₓ₀(θ₁₍₀₎+π)), and assuming that realisations ω̅ₓ₀(θ₁₍₀₎) and ω̅ₓ₀(θ₁₍₀₎+π) are independent, we have:

$$var ( {\overline{\overline{ω}}}_{x 0}^{( i )} = ( {θ}_{1 ( 0 )} ) ) = \frac{1}{2} var ( {\overline{ω}}_{x 0} ( {θ}_{1 ( 0 )} ) ) \qquad ( 33 )$$

In the idealized hypothesis in which sequences {dₓ(t)}, {d_{y}(t)} would be white noise sequences, of variance

$${η}_{0}^{2} ,$$

we would have var

$$( {\overline{ω}}_{x 0} ( {θ}_{1 ( 0 )} ) ) = \frac{1}{τ} {η}_{0}^{2}$$

and thus, due to relation (33), we would have var

$$( {\overline{\overline{ω}}}_{x 0}^{( i )} = ( {θ}_{1 ( 0 )} ) ) = \frac{1}{2 τ} {η}_{0}^{2} ,$$

and due to relation (31), we would have var

$$( {\overline{\overline{\overline{ω}}}}_{x 0} = ( {θ}_{1 ( 0 )} ) ) = \frac{1}{2 N τ} {η}_{0}^{2} .$$

It is then to be noticed that T=2Nτ corresponds to the total time passed in poses at positions θ₁₍₀₎ and θ₁₍₀₎+π for a given position θ₂ of axis 2 (0 ou π).

Therefore, assuming that noises of the gyrometers are white noises, var

$$( {\overline{\overline{\overline{ω}}}}_{x 0} ( {θ}_{1 ( 0 )} ) )$$

would depend only on the product T=2Nτ, no matter then for a given T the values of N and τ.

This idealized assumption of white noise of the gyrometers would be translated on the Allan curve (standard deviation as a function of a noise integration time) by a slope

$$- \frac{1}{2}$$

(reference can be made for that purpose to the book of Hervé Lefèvre “The fiber optic gyroscope, 3rd edition” Artech House Publishers (2022), section 2.3), which corresponds to an angular random walk. This noise integration time corresponds to the measurement duration.

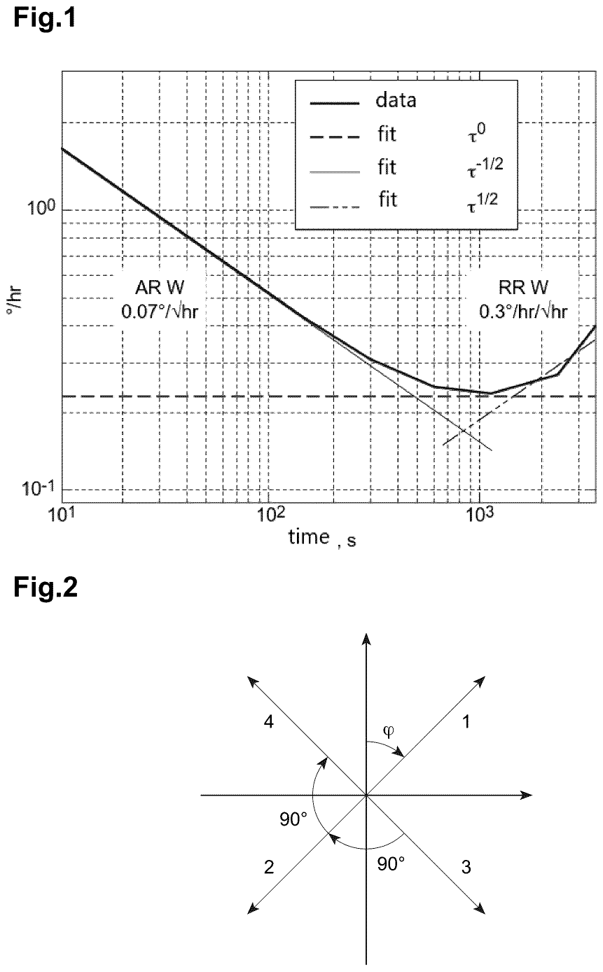

An example of Allan curve of a gyrometer is shown in FIG. 1 and a minimum in the evolution of the standard deviation of the measurements as a function of the measurement duration can be seen, this minimum, which corresponds to the “bias instability” of the gyrometer, corresponding to a measurement duration that is the “Allan curve correlation time”.

Actually, the gyrometer noise is never white, and a rise in the Allan curve is observed for long integration times corresponding to a slope

$$+ \frac{1}{2}$$

signing the presence of a rate random walk. The Allan curve minimum (located between the slopes

$$- \frac{1}{2} and + \frac{1}{2} )$$

is conventionally called “bias instability”.

Within the framework of “maytagging”, the present state of art (see for example the article, I. P. Prikhodko, S. A. Lotov, A. A. Trusov, A. M. Shkel “What is MEMS Gyrocompassing? Comparative Analysis of Maytagging and Carouseling”, IEEE Journal of Micromechanical systems (2013)) prescribes that the time 2τ is equal to the integration time in the Allan curve for which the “bias instability” (Allan curve minimum) is reached, this time being called correlation time (cf. the above-mentioned book by Hervé Lefèvre).

Within the framework of the present disclosure, this correlation time is called “Allan curve correlation time”.

The inventor has determined within the framework of the procedure derived from “maytagging” implemented in the invention and due to the fact that the gyrometer noise is not only white, that for a whole measurement duration T, the optimum of the pose time τ is significantly lesser than the Allan curve correlation time. Therefore, it is proposed to take a pose time τ significantly less than the gyrometers' Allan curve correlation time, and thus to increase N, the iteration number (cf. equations (10) to (13)). Advantageously, a pose time τ less than or equal to one-tenth of the gyrometers' Allan curve correlation time is implemented.

This is explained by the faster frequency of measurements due to the small pose time τ that operates a kind of “low-cut” filtering on noise.

It is therefore proposed to use a pose time τ the lowest possible for an iteration number N such that the whole measurement duration is less than the whole measurement duration T without iteration and with a pose time τ equal to the Allan curve correlation time.

For example, a maximum whole measurement duration Tmax can be calculated, equal to the whole measurement duration with implement invention but without iteration, N=1, and with a pose time τ equal to the Allan curve correlation time. Advantageous solutions of couples of pose times t less than the Allan curve correlation time and N>1 are then determined, which make it possible to have a whole measurement duration T less than the maximum whole duration Tmax. In practice, it can be shown that choosing a pose time value t less than one order of magnitude, typically one-tenth or one-twentieth, of the Allan curve correlation time, makes it possible to eliminate much of the “rate random walk” of the gyrometer noise while reducing the whole measurement duration T with respect to that without iteration (N=1) and with a pose time τ equal to the Allan curve correlation time. The method of the invention is thus far more efficient than the known method without iteration and using a pose time τ equal to the Allan curve correlation time, and that for a high-quality result.

Finally, once the azimuth of the table base, \hat{ψ}, has been determined, one or more mirrors are placed on the base of the motion simulator, and the base of said motion simulator is caused to rotate by mechanical actions/operations in order to compensate for the angle \hat{ψ}, these rotations being controlled by means of an auto-collimator targeting the above-mentioned mirrors. This angle compensation \hat{ψ} can use other known means than mirrors.

Once the compensation obtained by rotation of the motion simulator base, this base is rigidly fixed in such a way that the motion simulator can no longer move with respect to Earth. It is understood that the support on which the base is fixed much not move with respect to Earth either.

In an alternative embodiment in which the base of the motion simulator is not desired to be moved or cannot be moved, the azimuth estimation obtained is stored in the memory of computer equipment that will serve to correct the measurements of the devices tested in the motion simulator.

It is understood that the invention can be applied to other configurations in which the external axis performs a rotation about axis yₛ, and the internal axis a rotation about axis z₂. It is the same in the case where the external axis would perform a rotation about axis zₛ and where the internal axis would perform a rotation about axis x₂ or y₂. In any case, the method would use one or two horizontal measurement axes with measurements in the four positions described and for the two opposite orientations along the vertical of the plate.

1-11. (canceled)

12. A method for estimating the azimuth, \hat{ψ}, of a motion simulator base including a plate mounted on the base to rotate about at least two mutually perpendicular axes, the plate having a flat reference face defining a plate plane, in which
a gyrometric system including at least one gyrometer adapted to measure an angular speed of rotation of the plate about its measurement axis in an inertial reference frame is attached to the reference face of the plate,
at least four sessions of measurement of the angular speed of rotation of the plate are performed during at least four poses of the plate in four different positions of the plate during a first main sequence and in four positions of the plate during a second main sequence, the plate being static during its poses and the measurement axis of the gyrometer being horizontal during the poses of the plate,
in the first main sequence, the plate is positioned so that, during the plate poses, the reference face is directed according to a first normal vector and the measurements are performed successively in the four successive plate pose positions,
in the second main sequence, the plate is positioned so that, during the plate poses, the reference face is oriented according to a second normal vector, opposite to the first normal vector, and the measurement sessions are performed successively in the four successive plate pose positions,
the four plate positions of each of the first and second main sequences being such that the horizontal measurement axis of the gyrometer is turned by an angle of 180° in absolute value between a first position and a second position, is turned by an angle of 90° in absolute value between the second position and a third position, is turned by an angle of 180° in absolute value between the third position and a fourth position,
the measurement sessions between each of the plate poses at each of the four plate positions being performed during substantially a same determined pose time τ less than or equal to half the gyrometer's Allan curve correlation time, said correlation time being the measurement duration that corresponds to the minimum of the standard deviation on the Allan curve corresponding to the bias instability, and the obtained measurements are averaged over this pose time to obtain an averaged session measurement,
in each of the first and second main sequences, two differentials of the averaged session measurements are calculated, including a first differential between the session measurement averaged at the first position and the session measurement averaged at the second position and a second differential between the session measurement averaged at the third position and the session measurement averaged at the fourth position,
each of the first and second main sequences is repeated a determined number of times N, N>1, and general averages of the differentials obtained by the repetition of the first and second main sequences are calculated, the azimuth being finally estimated by solving a linear system including the general averages of the differentials.

13. The estimation method according to claim 12, wherein the pose time is less than or equal to one-tenth of the Allan curve correlation time.

14. The estimation method according to claim 12, wherein the pose time is less than or equal to one-twentieth of the Allan curve correlation time.

15. The estimation method according to claim 12, wherein a single gyrometer is implemented.

16. The estimation method according to claim 13, wherein a single gyrometer is implemented.

17. The estimation method according to claim 12, wherein a set of three gyrometers having their measurement axes mutually perpendicular is implemented, the set of three gyrometers being an inertial or navigation unit and the three gyrometers having substantially identical Allan curve correlation times, the measurement sessions being performed during the plate poses by two same gyrometers that have their two measurement axes horizontal during all the plate poses.

18. The estimation method according to claim 13, wherein a set of three gyrometers having their measurement axes mutually perpendicular is implemented, the set of three gyrometers being an inertial or navigation unit and the three gyrometers having substantially identical Allan curve correlation times, the measurement sessions being performed during the plate poses by two same gyrometers that have their two measurement axes horizontal during all the plate poses.

19. The estimation method according to claim 12, wherein two gyrometers having their measurement axes mutually perpendicular are implemented, the two gyrometers being attached to the plate in such a way that their measurement axes are horizontal during the plate poses and the two gyrometers have substantially identical Allan curve correlation times.

20. The estimation method according to claim 13, wherein two gyrometers having their measurement axes mutually perpendicular are implemented, the two gyrometers being attached to the plate in such a way that their measurement axes are horizontal during the plate poses and the two gyrometers have substantially identical Allan curve correlation times.

21. The estimation method according to claim 12, wherein at least two gyrometers are implemented, and wherein the gyrometers used for the measurement sessions during the poses have Allan curve correlation times that are significantly different from each other, and a pose time τ is implemented, which is less than or equal to half the minimum value of the Allan curve correlation times of the gyrometers used.

22. The estimation method according to claim 13, wherein at least two gyrometers are implemented, and wherein the gyrometers used for the measurement sessions during the poses have Allan curve correlation times that are significantly different from each other, and a pose time τ is implemented, which is less than or equal to half the minimum value of the Allan curve correlation times of the gyrometers used.

23. The estimation method according to claim 12, wherein the first and second main sequences are repeated N times sequentially, the first main sequence being repeated N times, then the second sequence repeated N times.

24. The estimation method according to claim 13, wherein the first and second main sequences are repeated N times sequentially, the first main sequence being repeated N times, then the second sequence repeated N times.

25. The estimation method according to claim 12, wherein the first and second main sequences are repeated N times alternately, by N repetitions of a first main sequence executed once, followed by a second sequence executed once.

26. The estimation method according to claim 13, wherein the first and second main sequences are repeated N times alternately, by N repetitions of a first main sequence executed once, followed by a second sequence executed once.

27. The estimation method according to claim 12, wherein the first and second main sequences are repeated N times alternately and sequentially by repeating l times a first main sequence executed m times, followed by a second sequence executed m times, with m<N, l>1 and with the product of/by m equal to N.

28. The estimation method according to claim 13, wherein the first and second main sequences are repeated N times alternately and sequentially by repeating l times a first main sequence executed m times, followed by a second sequence executed m times, with m<N, l>1 and with the product of/by m equal to N.

29. The estimation method according to claim 12, wherein once the azimuth of the table base, \hat{ψ}, has been determined and for a setting of the base to north, at least one mirror is placed on the base of the motion simulator and the base of said simulator is caused to perform mechanical rotations in order to compensate for the angle \hat{ψ}, said mechanical rotations being controlled by means of an auto-collimator targeting the above-mentioned mirrors.

30. The estimation method according to claim 13, wherein once the azimuth of the table base, \hat{ψ}, has been determined and for a setting of the base to north, at least one mirror is placed on the base of the motion simulator and the base of said simulator is caused to perform mechanical rotations in order to compensate for the angle \hat{ψ}, said mechanical rotations being controlled by means of an auto-collimator targeting the above-mentioned mirrors.
